(19) United States
(12) Patent Application Publication
(10) Pub. No.: US 2019/0387692 A1
(43) Pub. Date: Dec. 26, 2019

(54) NETTING INSTALLATION FOR USE IN TREE FRUIT PRODUCTION

(71) Applicant: TROPICANA PRODUCTS, INC., Bradenton, FL (US)

(72) Inventors: Toby Ryan FITZSIMONS, Vadnais Heights, MN (US); Michael D. THEDE, Bradenton, FL (US)

(21) Appl. No.: 16/447,471

(22) Filed: Jun. 20, 2019

Related U.S. Application Data
(60) Provisional application No. 62/688,664, filed on Jun. 22, 2018.

(51) Int. Cl. A01G 13/02

(52) U.S. Cl. CPC A01G 13/0268

(57) ABSTRACT

A netting installation, for use in tree fruit production, which comprises a framework comprising a plurality of uprights which are mutually spaced to form an array of the uprights. Each upright is installed into the ground using a helical ground anchor, and has a combination of upper and lower slidable parts to removably fit an upper part onto a lower part which is installed in the ground. Cables are attached to the upper ends of the uprights to form a cable network at least 3 meters above the ground. A plurality of nets are mounted on the cable network to form an array of nets. A releasable net tethering system connects the nets to the cables using connectors fitted between the peripheral edge of a respective net and a cable, wherein each connector has a preset maximum threshold of tensile strength.

### CROSS REFERENCE TO RELATED APPLICATION

This application claims the benefit of provisional U.S. Application No. 62/688,664 entitled “Netting Installation for Use in Tree Fruit Production” filed Jun. 22, 2019, the entirety of which is incorporated herein in its entirety.

### BACKGROUND OF THE INVENTION

### Field of the Invention

The present invention relates to a netting installation for use in tree fruit production, and to a framework for such a netting installation. The present invention also relates to a plurality of fruit trees, for example in an orchard or grove, covered by the netting installation. The present invention has particular application in netting installations supporting a photo-selective light spectrum-modifying net above citrus trees.

### Description of the Prior Art

Citrus plants, such as orange, lemon and lime, are widely grown in citrus groves and there is an ever increasing need to increase crop yield, for example expressed as weight of citrus fruit per acre of citrus grove under cultivation in an environmentally sustainable manner. In particular, there is a desire to minimise water irrigation of the citrus grove, particularly in geographical regions which may have scare water resources. There is also a desire to minimise fertilizer application, which may be applied with water in a given proportion.

It is known to use nets to provide weather protection of plants and crops, including trees that grow fruits. For example, Ginegar Plastic Products, Inc. of Israel manufactures and sells netting under the trade name Polysack as a range of nets that protects plants and crops against damage caused by wind, hail, birds and insects. Some of these nets also provide light spectrum management of the plants, for example, nets sold under the product names Pearl Leno, Crystal Leno, Red Leno and ChromatiNet Red Hail. For the red nets, it is disclosed that the net combines hail-protection together with light-spectrum management in greenhouses and shade houses, which protects against damage from hail, sunstroke and wind in orchards and vineyards; the net increases the red and far red spectrum that passes through it and creates a unique light composition to improve yields, accelerate growth, increase fruit size and bring forward fruit ripening. Light managements nets are also disclosed in U.S. Pat. No. 5,458,957 (Fryszer et al.), US Patent Application Publication No. 2002/0028620 (Guberman et al.) and US Patent Application Publication No. 2002/0056225 (Shahak et al.).

When used in an outdoor environment, the netting is mounted on a framework which supports the netting above the plants and crops. When the crops are tree fruits grown in an orchard or grove, the netting needs to be mounted above the top canopy of the trees, which is typically at a height of at least 3 meters above the ground level. The framework typically comprises vertical metal poles supporting cables (i.e. wire rope) to provide a cable network extending horizontally above the top canopy to support an array of nets.

The framework is required not only to support the weight of the netting but also to be sufficiently robust to prevent or minimize damage to the framework and netting during adverse weather conditions. Moreover, the netting installation is required to be reliably secured to the ground. It is to be noted that some fruits, particularly citrus fruits, are grown in geographical regions that have a high risk of extreme weather events, such as hurricanes, which can expose the netting to extremely high wind velocities for prolonged periods of time. Netting installations over citrus groves in the United States have previously been destroyed by hurricane-force winds, resulting in significant losses in capital investment.

Consequently, conventional netting installations typically rely upon the abundant use of concrete to secure the poles and cables to secure foundations in the ground. Known construction methods rely upon the use of concrete as a dead weight to counteract the upward force of wind on the netting.

However, many growing areas possess soil conditions that prohibit concrete trucks from entering a grove or orchard either at all or without the risk of tree damage. Additionally or alternatively, in many growing areas, where there is a high risk of adverse weather conditions, particularly high winds, the location of the structure would require extensive concrete for supporting the framework uprights and securing the netting to prevent the structure from failing.

The netting of the netting installation has a large surface area, which can create significant uplift during high wind events, since the large netting surface area tends to act as a sail during high wind events, for example during a hurricane. Therefore a large volume or weight of concrete per pole must be used to prevent the nets from lifting the framework structure out of its foundation.

Typically, in a conventional netting installation a volume of more than 1.75 m³ (typically 2 cubic yards) of concrete, requiring more than 130 27 kg (60-lb) bags of concrete mix, is required to make the concrete foundation for each pole to provide a sufficient holding force to reliably secure the pole in the ground. This requirement for large concrete volumes creates multiple challenges during installation of the netting installation, including transport of concrete to the area, and securing the pole to prevent pole shift until the concrete cures, which can typically take several weeks. The requirement for large volumes of concrete per upright, and consequently correspondingly per tree, therefore increases the cost, complexity and time for installation, and limits where the large volumes of concrete can be located within a grove or orchard, as the excavation of a large hole for receiving the concrete must not damage tree roots and the final concrete body must not restrict root growth or reduce effective irrigation.

Furthermore, if the uprights of conventional netting installations are damaged and require replacement, it is difficult and time consuming to remove the existing pole and install a replacement pole.

In addition, the conventional netting installations are designed and installed so that the entire installation of both framework and netting has sufficient structural strength to act as a unified structure to withstand expected or “normal” weather events. The framework is securely anchored in the ground and the netting is likewise securely fitted to the framework. However, in the event of an unusually severe or unexpected weather event, such as a hurricane, the entire structure may be destroyed. This would lead to significant capital losses.

Thus the conventional netting installation suffers from a number of technical problems.

There is therefore a need in the art for a netting installation which can be utilized in areas of high wind risk or when poor soil conditions are a mitigating factor.

There is a need in the art for a netting installation which can be quickly and reliably installed, particularly in geographical regions that may be subjected to high winds, even of hurricane force, without requiring large volumes of concrete foundations for the poles, or at least requiring smaller volumes of concrete than have been used in known or conventional netting installations as described above.

There is a need in the art for a netting installation which can have a lower total installation cost than known or conventional netting installations as described above.

There is a need in the art for a netting installation which can provide improve structural robustness, particularly when subjected to high winds, even of hurricane force, as compared to known or conventional netting installations as described above.

There is a need in the art for a netting installation which can be readily modified to be customized to a desired maximum wind speed.

There is a need in the art for a netting installation in which an agricultural canopy structure exhibits greater robustness than conventional designs.

The present invention aims at least partially to meet one or more of those needs.

### SUMMARY OF THE INVENTION

The present invention accordingly provides a framework for supporting a netting installation for use in tree fruit production, the framework comprising:

a plurality of uprights which are mutually spaced to form an array of the uprights, the upright having a lower end which is installed into a respective area of ground, and an upper end, wherein the upright comprises, at the lower end of the upright, a helical screw-in anchor helically screwed into the ground and, at the upper end of the upright, an elongate post member fitted to a shaft of the helical screw-in anchor, the helical screw-in anchor comprising a helical screw part at a bottom part of the shaft; and a plurality of cables attached to the upper ends of the uprights, the cables extending between the uprights to form a cable network at a height at least 3 meters above the ground, wherein the cable network forms an array of mutually spaced cables for mounting a plurality of nets on the cable network.

In preferred embodiments of the present invention, the upright comprises a body of concrete surrounding at least one of the shaft and the elongate post member, the body of concrete being embedded in the ground. Typically, the body of concrete is located above the respective helical screw part of the helical screw-in anchor. Preferably, the body of concrete has an upper part which surrounds the elongate post member and a lower part which surrounds the shaft of the helical screw-in anchor. In particularly preferred embodiments, the body of concrete has a volume of from 0.05 to 0.5 m³, optionally from 0.05 to 0.3 m³, further optionally from 0.05 to 0.25 m³. In particularly preferred embodiments, the body of concrete is cylindrical and coaxial with the shaft.

In preferred embodiments of the present invention, the elongate post member is fitted over a top end of the shaft of the helical screw-in anchor. The framework typically further comprises a bolt which extends through the elongate post member and the top end of the shaft to affix the elongate post member to the shaft of the helical screw-in anchor.

In preferred embodiments of the present invention, the elongate post member comprises a top part which provides the upper end of the upright and a bottom part which is coupled to the top part and is affixed to the shaft of the helical screw-in anchor. Preferably, the top part and the bottom part are slidably coupled together. Typically, a lower end of the top part is a tube which is slidably coupled as a sleeve over an upper tubular end of the bottom part. In particularly preferred embodiments, the top part is above a ground level and the bottom part is partly above the ground level and partly below the ground level.

In preferred embodiments of the present invention, the framework further comprises a cable clamping device located at the upper end of the upright. Typically, the cable clamping device comprises a curved rigid washer and a bolt extending though the washer and fitting the washer to the upright, the washer having a concave surface facing an outer surface of the upright and defining a gap between the concave surface and the outer surface, the gap being configured to compression clamp a cable in the gap between the washer and the upright.

In preferred embodiments of the present invention, the framework further comprises a plurality of perimeter anchors which are located around a perimeter of the framework, the perimeter anchor comprising a helical screw-in anchor helically screwed into the ground and a tensioning cable assembly fitted between the helical screw-in anchor and the upper end of at least one upright. Typically, the tensioning cable assembly includes a turnbuckle for adjusting the tension of the tensioning cable assembly. Preferably, the framework further comprises a cable fitting device located at the upper end of the upright for attachment by the tensioning cable assembly.

In particularly preferred embodiments, the cable fitting device comprises at least one rigid bar extending through the upright to provide two opposite ends of the rigid bar located externally of the upright on opposite sides of the upright, whereby a cable can be wrapped around the cable fitting device and the upright to fit the cable at a fixed height on the upright. The cable fitting device for example comprises two rigid bars which are mutually inclined, and typically are mutually orthogonal.

In preferred embodiments of the present invention, the array of the uprights is a regular rectangular array, comprising a plurality of parallel linear first rows of uprights extending in a first direction and a plurality of parallel linear second rows of uprights extending in a second direction which is orthogonal to the first direction. Such a rectangular array may have sides of different length or of equal length (i.e. a square). However, in other embodiments of the present invention the array of the uprights may form an irregular array or a regular having a non-rectangular shape, for example a circular array, A circular array may be desired when, for example, the trees circularly surround a well-head for irrigation.

The present invention further provides a framework for supporting a netting installation for use in tree fruit production, the framework comprising:

a plurality of uprights which are mutually spaced to form an array of the uprights, the upright having a lower end which is installed into a respective area of ground, and an upper end, wherein the upright comprises, at the lower end of the upright, an anchor installed into the ground and, at the upper end of the upright, an elongate post member fitted to a shaft of the anchor, wherein the elongate post member comprises a top part which provides the upper end of the upright and a bottom part which is coupled to the top part and is fitted to the shaft of the anchor, wherein the top part is above a ground level and the bottom part is partly above the ground level and partly below the ground level; and a plurality of cables attached to the upper ends of the uprights, the cables extending between the uprights to form a cable network at a height at least 3 meters above the ground, wherein the cable network forms an array of mutually spaced cables for mounting a plurality of nets on the cable network.

The present invention yet further provides a netting installation for use in tree fruit production, the netting installation comprising:

a framework comprising a plurality of uprights which are mutually spaced to form an array of the uprights, the upright having a lower end which is installed into a respective area of ground, and an upper end;

a plurality of cables attached to the upper ends of the uprights, the cables extending between the uprights to form a cable network at a height at least 3 meters above the ground, wherein the cable network forms an array of mutually spaced cables for mounting a plurality of nets on the cable network;

a plurality of nets mounted on the cable network, wherein the plurality of nets form an array of nets, wherein each net has a peripheral edge; and

a releasable net tethering system for connecting the nets to the cables, wherein the releasable net tethering system comprises a plurality of connectors fitted between the peripheral edge of a respective net and a cable, wherein the connector has a preset maximum threshold of tensile strength.

In preferred embodiments of the present invention, the connectors are loop connectors, preferably zip-ties, fitted around the peripheral edge of a respective net, the loop connector, preferably a zip-tie, forming a closed loop enclosing a cable and a part of the peripheral edge. Typically, a plurality of the loop connectors, preferably zip-ties, are uniformly spaced around the peripheral edge of the net. Preferably, the loop connectors, preferably zip-ties, are spaced around the peripheral edge of the net with a spacing of from 25 to 100 cm between adjacent loop connectors. In particularly preferred embodiments, each connector around the peripheral edge of the net has a common maximum threshold of tensile strength, for example within the range of from 10 to 20 kg. Typically, each connector, e.g. zip-tie, is composed of a polymer.

In preferred embodiments of the present invention, adjacent first and second nets of the array of nets are mounted to have respective first and second peripheral edge portions which are connected by respective first and second groups of connectors to a common cable assembly substantially aligned with the first and second peripheral edge portions. Typically, the connectors of the first and second groups of connectors are respectively connected in an alternating manner to the common cable assembly. In particularly preferred embodiments, the common cable assembly comprises a pair of aligned first and second cables and the connectors of the first and second groups of connectors are respectively connected to the first and second cables. Alternatively, when the common cable assembly comprises a pair of aligned first and second cables, at least at one location around a periphery of the net, the connectors of the first and second groups of connectors are connected to both the first and second cables.

In preferred embodiments of the present invention, the first and second peripheral edge portions are mutually spaced by a spacing extending between the adjacent first and second nets of the array. Typically, the spacing has a width of from 5 to 50 cm. Typically, each of the adjacent nets are each separated by the spacing. In particularly preferred embodiments, the peripheral edge comprises a row of reinforcement rings and each connector passes through a respective reinforcement rings to form a closed loop enclosing the cable or cables and the part of the peripheral edge.

In preferred embodiments of the present invention, each net of the netting installation has a surface area of from 5 to 25 m². However, other net dimensions may be employed. Typically, the array of nets is substantially horizontal.

In preferred embodiments of the present invention, in the netting installation the array of the uprights is a regular rectangular array, comprising a plurality of parallel linear first rows of uprights extending in a first direction and a plurality of parallel linear second rows of uprights extending in a second direction which is orthogonal to the first direction.

The present invention yet further provides a plurality of fruit trees, for example in an orchard or grove, covered by the netting installation of the present invention, wherein the trees are mutually spaced to define a regular rectangular array of the trees, wherein at least some of the first rows of uprights each extend along a respective first row of trees and at least some of the second rows of uprights each extend along a respective second row of trees. Typically, the trees are citrus trees, and may comprise orange, lemon, lime, grapefruit or pomelo trees. In preferred embodiments, the array of nets is mounted at a height of from 1 to 3 meters above a top canopy of the trees. In particularly preferred embodiments, the nets are photo-selective light spectrum-modifying nets.

The preferred embodiments of the present invention can provide a netting installation for photo-selective light spectrum-modifying net for use in citrus fruit production. Such a photo-selective light spectrum-modifying net can remarkably increase citrus yield, particularly from a mature citrus grove when the net is supported above the citrus tree(s). The present invention has particular application in the production of oranges, most particularly for fruit juice production.

The preferred embodiments of the present invention can provide a netting installation utilizing a novel combination of techniques including soil screw anchors, wind speed determinate netting release, and a slidable coupling as a sleeve between a top part of the elongate post member and the screw anchor (either directly or by an intermediate bottom part of the elongate post member), hereinafter referred to as a pipe sleeve, that allow for netting construction in areas of high wind risk or when poor soil conditions are a mitigating factor. The netting installation can exhibit improved structural robustness despite using a smaller volume of concrete in the foundations. The netting installation can readily be used in a variety of soil conditions, in particular that would otherwise prohibit concrete trucks from entering. The netting installation can readily be used in geographical regions subject to the risk of high winds, which would otherwise require extensive concrete and netting securing to prevent the structure from failing. The preferred embodiments of the present invention can provide a netting installation which can be custom designed for given environmental parameters.

In the preferred embodiments of the present invention, soil screw anchors are used to install poles in the soil subsurface quickly. A soil screw anchor is capable of resisting in excess of 3600 kg (about 8,000 lbs) of force before it fails and take less than 5 minutes to install using non-professional crews. The soil screw anchor can be further anchored by a small volume of concrete, although this is optional and not essential.

Furthermore, in the preferred embodiments of the present invention, the attachment of the vertical poles to the screw anchors can be achieved using a slidable sleeve structure, in which a large diameter uppermost pole is slid over a smaller diameter of pole extending out of the foundation. The sliding connection is removable. Consequently, the slidable sleeve structure allows for reduced downtime should any damage occur to the poles by allowing removal of a single uppermost pole only, rather than an entire pole assembly, including the anchor and the concrete further anchoring the pole into the ground.

In addition, the preferred embodiments of the present invention provide a wind determinate canopy release using connectors, such as zip-ties, which are configured to fail at a set maximum tensile force and thereby release the net from the framework before damage to the framework structure occurs. In particularly preferred embodiments, the connectors are installed at a set separation distance from one another, the distance being selected so that the net is secured to the framework to provide a preset maximum wind speed, and different separation distances can provide different known preset maximum wind speeds. Accordingly, it is possible to adjust the release of the nets at different wind speeds.

The preferred embodiments of the present invention can provide a netting installation including a photo-selective light spectrum-modifying net which can increase citrus yield from a citrus grove, particularly from a grove of young or mature citrus trees already in commercial production. The enhanced yield can be achieved by providing the net above the citrus trees, and therefore the yield can be increased or maintained with reduced irrigation, and reduced energy and fertilizer input.

### BRIEF DESCRIPTION OF THE DRAWINGS

Embodiments of the present invention will now be described by way of example only with reference to the accompanying drawings, in which:

FIG. 1 schematically illustrates a side view of a part of a netting installation for use in tree fruit production in accordance with an embodiment of the present invention;

FIG. 2 schematically illustrates a plan view of the part of the netting installation of FIG. 1 over a plurality of fruit trees;

FIG. 3 schematically illustrates in greater detail a plan view of part of the netting installation of FIG. 1 between adjacent uprights of a framework of the netting installation;

FIG. 4 schematically illustrates in greater detail a plan view of part of the netting installation of FIG. 1 above an upright;

FIG. 5 schematically illustrates the ground installation of the upright in the netting installation of FIG. 1;

FIG. 6 schematically illustrates the top of an upright in the netting installation of FIG. 1 showing a cable clamping device for clamping the cable network and a fixing device for a cable tensioning device of a perimeter anchor; and

FIG. 7 schematically illustrates in greater detail a cable clamping device at the top of an upright in the netting installation of FIG. 1.

### DETAILED DESCRIPTION OF THE EMBODIMENTS OF THE INVENTION

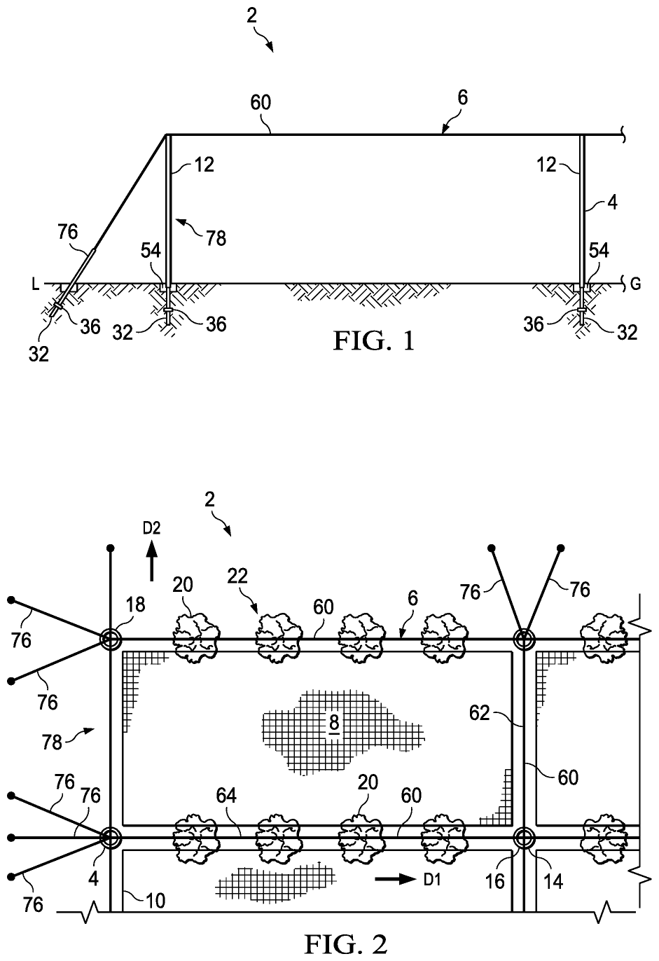

Referring to FIGS. 1 to 7, there is shown a netting installation 2 according to an embodiment of the present invention for use in tree fruit production, in particular for production of citrus fruit from orange, lemon, lime, grapefruit or pomelo trees, pomaceous fruit, for example from apple or pear trees, stone fruit such as peaches, apricots, plums and nectarines, or nuts, such as almonds. The present invention has particular application in preferred embodiments for use in the production of oranges, in particular for fruit juice production.

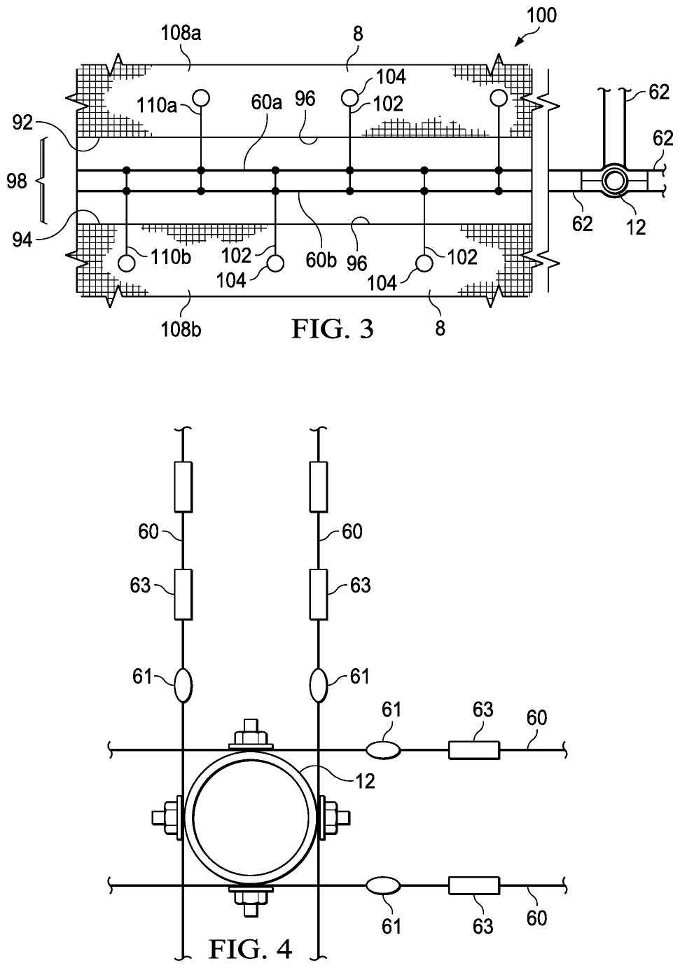

The netting installation 2 comprises a framework 4 for supporting a cable network 6. A plurality of nets 8 (partly illustrated by a mesh pattern in FIGS. 2 and 3) are mounted on the cable network 6. The plurality of nets 8 form an array 10 of the nets 8 which are mounted in a side-by-side configuration. Each net 8 typically has a surface area of from 5 to 25 m². Each net 8 is typically rectangular and has a length of from 10 to 20 m and a width of from 5 to 15 m. Any suitable net dimensions may be used, and any suitable two-dimensional shape. The array 10 may have any total size and two-dimensional shape to cover the desired area of trees.

The array 10 of nets 8 is substantially horizontal. The array of nets is typically mounted at a height of from 1 to 3 meters above a top canopy of the trees. Typically, the nets 8 are photo-selective light spectrum-modifying nets. The netting installation 2 is preferably at least 50% open-sided (i.e. at least 50% of the total area of the sides of the netting installation is not covered by netting or any other material), and so the nets of the netting installation 2 preferably consist of, i.e. comprise only, a substantially horizontal array 10 of nets 8.

The framework 4 comprises a plurality of uprights 12 which are mutually spaced to form an array 14 of the uprights 12. Typically, the array 14 of the uprights 12 is a regular rectangular array 14, comprising a plurality of parallel linear first rows 16 of uprights 12 extending in a first direction D1 and a plurality of parallel linear second rows 18 of uprights 12 extending in a second direction D2 which is orthogonal to the first direction D1. The regular rectangular array 14 may comprise rectangles or squares (i.e. rectangles of equal sides). As described above, the array 14 of the uprights 12 may be regular having a different shape, e.g. circular, or irregular.

The netting installation 2 covers a plurality of fruit trees 20 in an orchard (e.g. of pomaceous fruit trees, such as apple and pear trees) or grove (e.g. of citrus trees). The trees 20 are mutually spaced to define a regular rectangular array of the trees. At least some of the first rows 16 of uprights 12 each extend along a respective first row 22 of trees 20. Preferably, the nets 8 are photo-selective light spectrum-modifying nets.

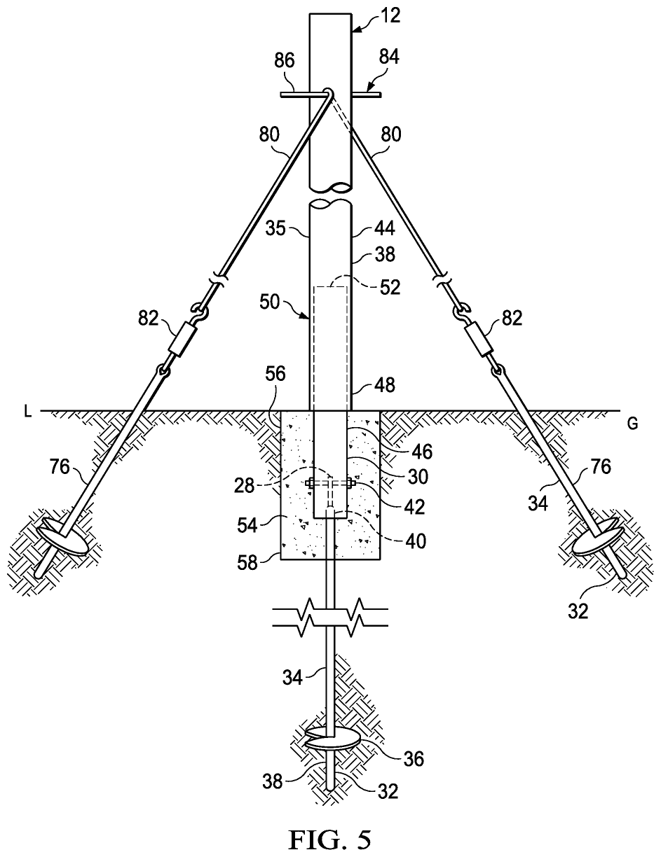

Referring in particular to FIG. 5, each upright 12 has a lower end 30 which is installed into a respective area of ground G. At the lower end 30 of the upright 12, a helical screw-in anchor 32 is helically screwed into the ground G (only the end portions of the helical screw-in anchor 32 are shown in FIG. 5 for clarity of illustration). The helical screw-in anchor 32 comprises a shaft 34 and a helical screw part 36 at a bottom part 38 of the shaft 34. Such helical screw-in anchors 32 are commercially available in a variety of different sizes.

In the preferred embodiments of the present invention, the helical screw part 36 is composed of steel, for example galvanized steel, and includes an auger having an external diameter of about 25 to 40 cm, and the shaft 34 has a diameter of about 25 to 40 mm and a length of about 2 to 3 m, although other dimensions may be employed for a given soil condition and desired netting installation.

An elongate post member 38 is fitted to an upper end of the shaft 34 of the helical screw-in anchor 32. The elongate post member 38 is fitted over a top end 40 of the shaft 34. A bolt 42, or other bolt-like structure such as a rod, extends through the elongate post member 38 and the top end 40 of the shaft 34, for example through a hole or other suitable fitting 28 provided at the top end 40 of the shaft 34, to affix the elongate post member 38 to the shaft 34.

The elongate post member 38 comprises a top part 44 which provides the upper end 35 of the upright 12 and a bottom part 46 which is coupled to the top part 44 and is affixed to the shaft 34, in particular by the bolt 42 as described above. The top part 44 and the bottom part 46 are slidably coupled together. A lower end 48 of the top part 44 is a tube which is slidably coupled as a sleeve 50 over an upper tubular end 52 of the bottom part 46. The top part 44 is above a ground level L and the bottom part 46 is partly above the ground level L and partly below the ground level L. Typically, the elongate post member 38 comprises a pair of metal (e.g. galvanized steel) tubular poles having a telescoping arrangement, with the larger internal diameter top part 44 slidably received over the smaller outer diameter bottom part 46.

In the illustrated embodiment, the top part 44 is a galvanized steel tube which has an outer diameter of about 100 mm and a wall thickness of about 4 mm and the bottom part 46 is a galvanized steel tube which has an outer diameter of about 85 mm and a wall thickness of about 4 mm. These dimensions enable the top part 44 to slide over the bottom part 46 and for both assembled parts to provide an upright 12 which exhibits structural strength. The top part 44 has a length to provide the required height of the netting. In the illustrated embodiment, the top part 44 of the upright 12 extends about 6 meters above the ground level L. In the illustrated embodiment, the bottom part 46 extends a distance of about 30 cm below the ground level L and extends a height of about 60 cm above the ground level L.

Each upright 12 also respectively comprises a body of concrete 54 surrounding at least one of the shaft 34 and the elongate post member 38. Preferably, the body of concrete 54 is located above the respective helical screw part 36 of the helical screw-in anchor 32. The body of concrete 54 has an upper part 56 which surrounds the elongate post member 38 and a lower part 58 which surrounds the shaft 34 of the helical screw-in anchor 32. In the illustrated embodiment, the body of concrete 54 surrounds an upper portion of the shaft 34 and a lower portion of the bottom part 46 which is below the ground level L. The body of concrete 54 is embedded in the ground G, and preferably the upper surface 59 of the body of concrete 54 is substantially at the ground level L.

Typically, the body of concrete 54 has a volume of from 0.05 to 0.5 m³, optionally from 0.05 to 0.3 m³, further optionally from 0.05 to 0.25 m³. In the illustrated embodiment, the body of concrete 54 is a cube of approximate dimensions 45×45×45 cm has a volume of about 0.1 m³ (dimensions of 18×18×18 inches with a volume of approximately 3.375 cubic feet). However, the body of concrete 54 may have any desired shape and configuration, which may be regular, for example a cube or cylinder, or irregular, for example any random shape of the required volume to function as an additional weight for the upright 12. In a particularly preferred embodiment, the body of concrete 54 is a cylinder, so that the hole in the ground G which is required to be formed to receive the concrete can be formed by an auger. The auger can be operated by being rotated by a drilling machine that may also be used to rotate the helical screw-in anchor 32 in order to helically screw the helical screw-in anchor 32 into the ground G. In particularly preferred embodiments, the body of concrete 54 is cylindrical and coaxial with the shaft 34.

In order to install the upright 12, a hole is excavated in the ground G which has a size and shape to accommodate the subsequently poured volume of concrete to form the body of concrete 54. The helical screw-in anchor 32 is screwed into the ground G to a desired depth, and typically so that the fitting 28 provided at the top end 40 of the shaft 34 is about 25 to 40 cm below the ground level. This provides that the helical screw-in anchor 32 typically extends to a depth of from 2 to 3.5 meters, more typically from 2.5 to 3 meters, into the ground G. Then the bottom part 46 of the elongate post member 38 is located over shaft 34 and the bolt 42 is used to affix the bottom part 46 of the elongate post member 38 to the shaft 34 via fitting 28.

The bottom part 46 of the elongate post member 38 is held in a vertical orientation, and then the desired volume of concrete is poured into the excavated hole, and the concrete then sets and cures to form the body of concrete 54. The lower end of the upright 12 is thereby quickly and securely installed in the ground G using only a minimal volume of concrete and minimal groundwork/excavations. The small volume of concrete sets quickly, within hours.

This preferred installation procedure minimizes disruption to existing trees, and the minimal groundwork enables the uprights to be located within a line of trees, and between adjacent trees in the line, without causing damage to trees or their root structure. By aligning the uprights with the lines of trees, vehicular access to the trees, for example for use in harvesting, in maximized.

After the bottom part 46 of the elongate post member 38 has been securely installed in the ground G as described above, the upper part 44 of the elongate post member 38 can readily be slid, as a sleeve fitting, over the bottom part 46 to install the entire upright 12.

Again, this is a quick and convenient installation procedure. In the event that the upper part 44 of the elongate post member 38 requires removal or replacement, for example as a result of damage due to adverse weather conditions, the upper part 44 can easily be slid upwardly off the bottom part 46, and a new upper part 44 subsequently installed to replace or repair the upright 12.

The framework 4 further comprises a plurality of perimeter anchors 76 which are located around a perimeter 78 of the framework 4. The perimeter anchors 76 are provide to provide enhanced structural support for the net-supporting framework 4 around its perimeter 78. As illustrated in FIG. 2, one of more of the perimeter anchors 76 may be fitted to an upright 12, and the number and configuration of the perimeter anchors 76 is selected to provide the desired structural support for the framework 4 at the specific installation location.

As shown also in FIG. 5, each perimeter anchor 76 comprises a helical screw-in anchor helically 32 screwed into the ground G and a tensioning cable assembly 80 fitted between the helical screw-in anchor 32 and the upper end 35 of at least one upright 12. The tensioning cable assembly 80 includes a turnbuckle 82 for adjusting the tension of the tensioning cable assembly 80. The perimeter anchors 76 may optionally be provided with a body of concrete, as described above for the uprights 12, but this is not essential and may be omitted.

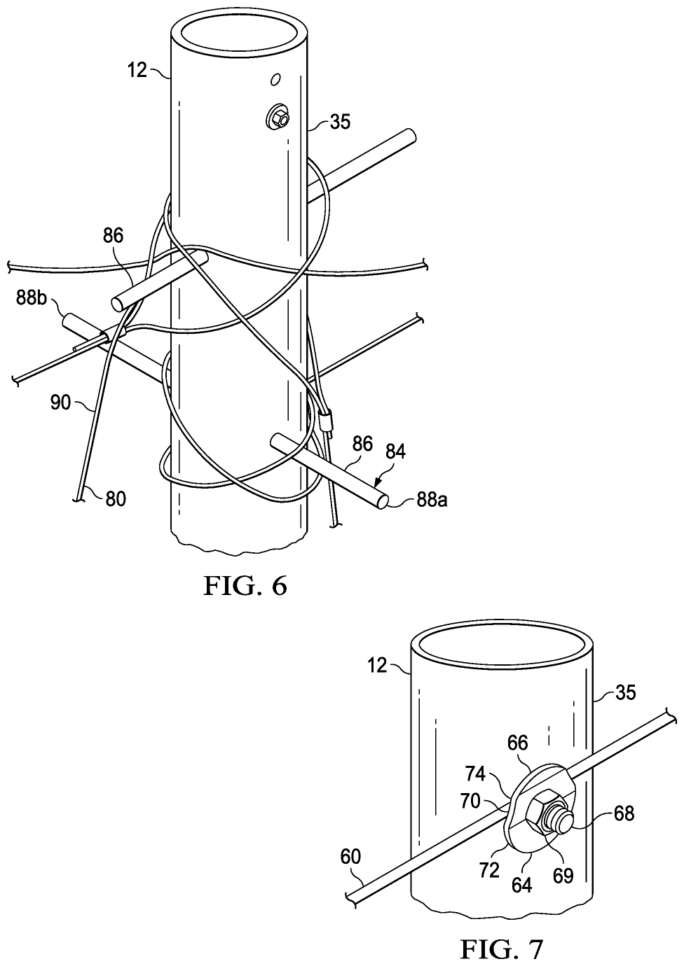

As shown also in FIG. 6, a cable fitting device 84 is located at the upper end 35 of the upright 12 for attachment by the tensioning cable assembly 80. The cable fitting device 84 comprises at least one rigid bar 86 extending through the upright 12 to provide two opposite ends 88a, 88b of the rigid bar 86 located externally of the upright 12 on opposite sides of the upright 12. The cable fitting device 84 typically comprises two rigid bars 86 which are mutually inclined, preferably mutually orthogonal.

A tensioning cable 90 of the tensioning cable assembly 80 can be wrapped around the cable fitting device 84 and the upright 12 to fit the tensioning cable 90 at a fixed height on the upright 12.

After the uprights 12 have been installed as described above, the perimeter anchors 76 can be installed and coupled to the uprights 12 by the tensioning cables 90. Again, the helical screw-in anchors 32 are installed in the ground G, but for the perimeter anchors 76 typically the helical screw-in anchors 32 are inclined to the vertical, for example at an angle of about 45 degrees to the vertical, and the helical screw-in anchors 32 are screwed into the ground G so that substantially the entire length of the helical screw-in anchor 32 is below the ground level L, leaving the fitting 28 exposed above ground G. Typically, the helical screw-in anchors 32 are screwed into the ground G to a depth of about 1.8 m.

Then the tensioning cable 90 is fitted to the fitting 28 and around the cable fitting device 84. The turnbuckle 82 is used to adjust the tension of the tensioning cable assembly 80 to a desired tension for supporting the periphery of the framework 4.

A plurality of cables 60 are attached to the upper ends 35 of the uprights 12. The cables 60 extend between the uprights 12 to form a cable network 62 at a height at least 3 meters above the ground G. The cable network 62 forms an array 64 of mutually spaced cables 60 for mounting the plurality of nets 8 on the cable network 62.

Typically, the cables 60 are high tensile strength steel cables having a typical diameter of from 6 to 15 mm. The cables 60 may be wholly or partially integral with, or wholly or partially separate from, the tensioning cables 90 of the tensioning cable assembly 80.

As described above, the array 10 of nets 8 is at a desired height above the top canopy of the trees. Accordingly, the cable network 62 is attached to the uprights 12 at a height above the ground level L to provide such a net height.

As shown also in FIG. 4, the cables 60 of the cable network 62 may be joined together by clip and thimble sets 61, which are well known in the cable art, and turnbuckles 63, which are also well known in the cable art, are used as cable tensioning devices.

As shown in FIG. 7, a cable clamping device 64 is located at the upper end 35 of the upright 12. Preferably, the cable clamping device 64 comprises a curved rigid washer 66 and a bolt 68, with an associated nut 69, extending though the washer 66 and fitting the washer 66 to the upright 12. The washer 66 has a concave surface 70 facing an outer surface 72 of the upright 12. The concave surface 70 defines a gap 74 between the concave surface 70 and the outer surface 72. The gap 74 is configured securely to compression clamp a cable 60 of the cable network 62 in the gap 74 between the washer 66 and the upright 12.

As described above, the plurality of nets 8 form an array 10 of the nets 8 which are mounted in a side-by-side configuration. Adjacent nets 8 have respective first and second peripheral edge portions.

As illustrated in FIG. 3, in the preferred embodiment the first and second peripheral edge portions 92, 94 of respective peripheral edges 96 are mutually spaced by a spacing 98 extending between adjacent first and second nets 8 of the array 10. Typically, the spacing 98 has a width of from 5 to 50 cm. Preferably, the adjacent nets 8 are each separated by the spacing 98, and so each net 8 has a peripheral edge 96 which is either at the periphery of the entire array 10 or is spaced from an adjacent net 8.

A releasable net tethering system 100 connects the nets 8 to the cables 60 of the cable network 62. The releasable net tethering system 100 comprises a plurality of connectors 102, preferably zip-ties 102, fitted around the peripheral edge 96 of a respective net 8. Each connector 102 has a preset maximum threshold of tensile strength, typically within the range of from 10 to 20 kg.

Typically, each connector 102, most preferably in the form of a zip-tie, forms a closed loop enclosing a cable 60 of the cable network 62 and a part of the peripheral edge 96. The peripheral edge 96 comprises a row of reinforcement rings 104 as shown in FIG. 3. The reinforcement ring 104 (otherwise referred to as a grommet) typically comprises a pair of metal rings which are affixed together, for example by screws, on opposite sides of the net with the net material sandwiched there between. The reinforcement ring 104 provide a high strength connection to the net 8 at a specific location on the net which prevents or minimizes tearing of the new material. Each closed loop connector, or zip-tie 102, passes through a respective reinforcement ring 104 to form the closed loop enclosing the cable 60 and the part of the peripheral edge 96.

The plurality of zip-ties 102 are uniformly spaced around the peripheral edge 96 of the net 8. The zip-ties 102 are spaced around the peripheral edge 96 of the net 8 with a spacing of from 25 to 100 cm between adjacent zip-ties 102. Each closed loop connector, or zip-tie 102, is preferably composed of a polymer, for example polypropylene or polyethylene.

Zip-ties are commonly commercially available, and different zip-ties are available that have different respective preset maximum thresholds of tensile strength. The zip-ties 102 around the peripheral edge 96 of the net 8 preferably have a common maximum threshold of tensile strength, preferably within the range described above.

As shown in FIG. 3, adjacent first and second nets 108a, 108b of the array 10 of nets 8 are mounted to have respective first and second peripheral edge portions 92, 94 which are connected by respective first and second groups 110a, 110b of zip-ties 102 to a common cable assembly 104 substantially aligned with the first and second peripheral edge portions 92, 94.

In the illustrated embodiment, the common cable assembly 104 comprises a pair of aligned first and second cables 60a, 60b and the zip-ties 102 of the first and second groups 110a, 110b are each connected to the first and second cables 60a, 60b. Preferably, the zip-ties 102 of the first and second groups 110a, 110b are respectively connected in an alternating manner to the common cable assembly 104.

In this embodiment, using a typical spacing between the uprights 12 (for example up to about 17 meters) and a typical galvanized steel cable diameter (for example about 4.5 to 6.5 mm), in order to minimize lateral deformation or stretch of the cables 60a, 60b as a result of the lateral pulling load applied to the cables 60a, 60b by the zip-ties 102, the zip-ties 102 are looped around both cables 60a, 60b at least at one location around the net periphery, optionally around the entire periphery of the net 8.

Such a fitting of each zip-tie 102 to both cables 60a, 60b prevents or minimizes the cables 60a, 60b stretching laterally into each net 8, which would otherwise reduce the total netting coverage. By bundling both cables 60a, 60b with at least some of, optionally all of, the zip ties 102 before fixing to the respective reinforcement ring 104, the lateral stretch of the cables 60a, 60b can be minimized and almost completely eliminated while still allowing the respective peripheral edges 96 of adjacent nets 8 to be reliably spaced by the spacing 98.

The illustrated embodiment comprising pair of cables 60a, 60b has the advantage of using cables which are relatively light in weight, and flexible, and have a low capital expense. The problem of lateral cable stretch can alternatively be overcome or avoided by using heavier/thicker cables and/or a shorter distance between adjacent uprights, but these alternative options would have the disadvantage of increased installation and component costs.

In alternative embodiment therefore, only a single cable 60 extends between the uprights 12, and the first and second groups 110a, 110b are respectively connected to the common cable 60 in an alternating arrangement.

In the preferred embodiments of the present invention, there is provided a releasable net tethering system for connecting the nets to the cables. The net tethering system comprises the plurality of connectors, preferably zip-ties, fitted between the peripheral edge of the nets via the reinforcement rings and the cable network. Each connector has a preset maximum threshold of tensile strength. The mutual separation, in a direction along the peripheral edges of the nets, of the connectors, and associated reinforcement rings, determines the total number of connectors per unit length of the periphery of the net. Each connector has a given maximum tensile strength before failure. Therefore the number and spacing of the connectors and reinforcement rings and the maximum tensile strength of the connector or zip-tie can be selected to provide a desired net releasability parameter representing the force required to be applied to the surface area of the net by wind in order to cause failure of the connectors and release of the net from being tethered to the cable network and consequently the framework.

For example, increasing the preset maximum threshold of tensile strength of the connectors and/or decreasing the mutual separation of the connectors, and associated reinforcement rings, would increase the net releasability parameter representing the force required to be applied to the surface area of the net by wind in order to cause failure of the connectors and release of the net from being tethered to the cable network and consequently the framework.

Therefore the use of the connectors having a given maximum tensile strength before failure, and a net tethering system which can readily vary the distance between the connectors, provides a highly versatile net installation in which, using a common framework of consistent structural strength, the net tethering system can be customised to a desired maximum wind speed prior to release of the net from the framework. The netting can be configured to be released from the framework at a desired wind speed, which ensures that the framework is not structurally damaged in the event of a high wind speed, for example from a hurricane. The releasable net tethering system provides that the net can be sacrificial at a given high wind speed, which ensures that the framework is not damaged. Of course, loss of the net in the event of a hurricane would be disruptive and incur costs for a replacement net and tethering system, which typically includes inexpensive zip-ties; however, that disruption and cost would be significantly lower than if the framework is damaged or destroyed. As described above, conventional netting installations may be entirely destroyed by a hurricane event, whereas the netting installation of the preferred embodiments of the resent invention may only require replacement of the netting and the inexpensive net tethering system.

Various other modifications to the present invention will be readily apparent to those skilled in the art.

1. A framework for supporting a netting installation for use in tree fruit production, the framework comprising:
i. a plurality of uprights which are mutually spaced to form an array of the uprights, the upright having a lower end which is installed into a respective area of ground, and an upper end, wherein the upright comprises, at the lower end of the upright, a helical screw-in anchor helically screwed into the ground and, at the upper end of the upright, an elongate post member fitted to a shaft of the helical screw-in anchor, the helical screw-in anchor comprising a helical screw part at a bottom part of the shaft; and
ii. a plurality of cables attached to the upper ends of the uprights, the cables extending between the uprights to form a cable network at a height at least 3 meters above the ground, wherein the cable network forms an array of mutually spaced cables for mounting a plurality of nets on the cable network.

2. The framework of claim 1 wherein the upright comprises a body of concrete surrounding at least one of the shaft and the elongate post member, the body of concrete being embedded in the ground.

3. The framework of claim 2 wherein the body of concrete is located above the helical screw part of the helical screw-in anchor.

4. The framework of claim 2 wherein the body of concrete has an upper part which surrounds the elongate post member and a lower part which surrounds the shaft of the helical screw-in anchor.

5. The framework of claim 2 wherein the body of concrete has a volume of from 0.05 to 0.5 m³ or from 0.05 to 0.3 m³ or from 0.05 to 0.25 m³.

6. The framework of claim 2 wherein the body of concrete is cylindrical and coaxial with the shaft.

7. The framework of claim 1 wherein the elongate post member is fitted over a top end of the shaft of the helical screw-in anchor.

8. The framework of claim 7 further comprising a bolt which extends through the elongate post member and the top end of the shaft to affix the elongate post member to the shaft of the helical screw-in anchor.

9. The framework of claim 1 wherein the elongate post member comprises a top part which provides the upper end of the upright and a bottom part which is coupled to the top part and is affixed to the shaft of the helical screw-in anchor.

10. The framework of claim 9 wherein the top part and the bottom part are slidably coupled together.

11. The framework of claim 10 wherein a lower end of the top part is a tube which is slidably coupled as a sleeve over an upper tubular end of the bottom part.

12. The framework of claim 10 wherein the top part is above a ground level and the bottom part is partly above the ground level and partly below the ground level.

13. The framework of claim 1 further comprising a cable clamping device located at the upper end of the upright.

14. The framework of claim 13 wherein the cable clamping device comprises a curved rigid washer and a bolt extending though the washer and fitting the washer to the upright, the washer having a concave surface facing an outer surface of the upright and defining a gap between the concave surface and the outer surface, the gap being configured to compression clamp a cable in the gap between the washer and the upright.

15. The framework of claim 1 further comprising a plurality of perimeter anchors which are located around a perimeter of the framework, the perimeter anchor comprising a helical screw-in anchor helically screwed into the ground and a tensioning cable assembly fitted between the helical screw-in anchor and the upper end of at least one upright.

16. The framework of claim 15 wherein the tensioning cable assembly includes a turnbuckle for adjusting the tension of the tensioning cable assembly.

17. The framework of claim 15 further comprising a cable fitting device located at the upper end of the upright for attachment by the tensioning cable assembly.

18. The framework of claim 17 wherein the cable fitting device comprises at least one rigid bar extending through the upright to provide two opposite ends of the rigid bar located externally of the upright on opposite sides of the upright, whereby a cable can be wrapped around the cable fitting device and the upright to fit the cable at a fixed height on the upright.

19. The framework of claim 18 wherein the cable fitting device comprises two rigid bars which are mutually inclined.

20. The framework of claim 19 wherein the two rigid bars are mutually orthogonal.

21. The framework of claim 1 wherein the array of the uprights is a regular rectangular array, comprising a plurality of parallel linear first rows of uprights extending in a first direction and a plurality of parallel linear second rows of uprights extending in a second direction which is orthogonal to the first direction.

22. A framework for supporting a netting installation, the framework comprising:
i. a plurality of uprights which are mutually spaced to form an array of the uprights, the upright having a lower end which is installed into a respective area of ground, and an upper end, wherein the upright comprises, at the lower end of the upright, an anchor installed into the ground and, at the upper end of the upright, an elongate post member fitted to a shaft of the anchor, wherein the elongate post member comprises a top part which provides the upper end of the upright and a bottom part which is coupled to the top part and is fitted to the shaft of the anchor, wherein the top part is above a ground level and the bottom part is partly above the ground level and partly below the ground level; and
ii. a plurality of cables attached to the upper ends of the uprights, the cables extending between the uprights to form a cable network at a height at least 3 meters above the ground, wherein the cable network forms an array of mutually spaced cables for mounting a plurality of nets on the cable network.

23. The framework of claim 22 wherein the top part and the bottom part are slidably coupled together.

24. The framework of claim 23 wherein a lower end of the top part is a tube which is slidably fitted as a sleeve over an upper end of the bottom part.

25. The framework of claim 22 wherein the upright comprises a body of concrete surrounding the at least one of the shaft and the elongate post member, the body of concrete being embedded in the ground.

26. The framework of claim 25 wherein the body of concrete is located above an anchoring part of the anchor.

27. The framework of claim 25 wherein the body of concrete has an upper part which surrounds the elongate post member and a lower part which surrounds the shaft of the anchor.

28. The framework of claim 25 wherein the body of concrete has a volume of from 0.05 to 0.5 m³ or from 0.05 to 0.3 m³ or from 0.05 to 0.25 m³.

29. The framework of claim 25 wherein the body of concrete is cylindrical and coaxial with the shaft.

30. The framework of claim 22 wherein the elongate post member is fitted over a top end of the shaft of the anchor.

31. The framework of claim 30 further comprising a bolt which extends through the elongate post member and the top end of the shaft to affix the elongate post member to the shaft of the anchor.

32. The framework of claim 22 wherein the anchor is a helical screw-in anchor helically screwed into the ground and, at the upper end of the upright, the helical screw-in anchor comprising a helical screw part at a bottom part of the shaft.

33. A netting installation, the netting installation comprising:
i. a framework comprising a plurality of uprights which are mutually spaced to form an array of the uprights, the upright having a lower end which is installed into a respective area of ground, and an upper end;
ii. a plurality of cables attached to the upper ends of the uprights, the cables extending between the uprights to form a cable network at a height at least 3 meters above the ground, wherein the cable network forms an array of mutually spaced cables for mounting a plurality of nets on the cable network;
iii. a plurality of nets mounted on the cable network, wherein the plurality of nets form an array of nets, wherein each net has a peripheral edge; and
iv. a releasable net tethering system for connecting the nets to the cables, wherein the releasable net tethering system comprises a plurality of connectors fitted between the peripheral edge of a respective net and a cable of the cable network, wherein the connector has a preset maximum threshold of tensile strength.

34. The netting installation of claim 33 wherein the connectors are loop connectors fitted around the peripheral edge of a respective net, each loop connector forming a closed loop enclosing a cable and a part of the peripheral edge.

35. The netting installation of claim 34 wherein the loop connectors comprise zip-ties.

36. The netting installation of claim 34 wherein the peripheral edge comprises a row of reinforcement rings and the loop connector passes through a respective reinforcement ring to form the closed loop enclosing the cable and the part of the peripheral edge.

37. The netting installation of claim 33 wherein the connectors are uniformly spaced around the peripheral edge of the net.

38. The netting installation of claim 33 wherein the connectors are spaced around the peripheral edge of the net with a spacing of from 25 to 100 cm between adjacent connectors.

39. The netting installation of claim 33 wherein the connectors around the peripheral edge of the net have a common maximum threshold of tensile strength.

40. The netting installation of claim 33 wherein each connector has a maximum threshold of tensile strength within the range of from 10 to 20 kg.

41. The netting installation of claim 33 wherein each connector is composed of a polymer.

42. The netting installation of claim 33 wherein adjacent first and second nets of the array of nets are mounted to have respective first and second peripheral edge portions which are connected by respective first and second groups of connectors to a common cable assembly substantially aligned with the first and second peripheral edge portions.

43. The netting installation of claim 42 wherein the connectors of the first and second groups of connectors are respectively connected in an alternating manner to the common cable assembly.

44. The netting installation of claim 42 wherein the common cable assembly comprises a pair of aligned first and second cables and the connectors of the first and second groups of connectors are respectively connected to the first and second cables or are connected to both of the first and second cables.

45. The netting installation of claim 42 wherein the first and second peripheral edge portions are mutually spaced by a spacing extending between the adjacent first and second nets of the array.

46. The netting installation of claim 45 wherein the spacing has a width of from 5 to 50 cm.

47. The netting installation of claim 45 wherein the adjacent nets are each separated by the spacing.

48. The netting installation of claim 33 wherein each net has a surface area of from 5 to 25 m².

49. The netting installation of claim 33 wherein the array of nets is substantially horizontal.

50. The netting installation of claim 33 wherein the array of the uprights is a regular rectangular array, comprising a plurality of parallel linear first rows of uprights extending in a first direction and a plurality of parallel linear second rows of uprights extending in a second direction which is orthogonal to the first direction.

51. A plurality of fruit trees covered by the netting installation of claim 50, wherein the trees are mutually spaced to define a regular rectangular array of the trees, wherein at least some of the first rows of uprights each extend along a respective first row of trees and at least some of the second rows of uprights each extend along a respective second row of trees.

52. The plurality of fruit trees of claim 51 wherein the trees are citrus trees.

53. The plurality of fruit trees of claim 52 wherein the array of nets is mounted at a height of from 1 to 3 meters above a top canopy of the trees.
